(19) United States
(12) Patent Application Publication
(10) Pub. No.: US 2025/0197549 A1
(43) Pub. Date: Jun. 19, 2025

(54) THERMO-RESPONSIVE AND CONDUCTING POLYMER WITH A REVERSIBLE SOL-GEL TRANSITION

(71) Applicants: Laure V. Kayser, Landenberg, PA (US); Vidhika S. Damani, Newark, DE (US)

(72) Inventors: Laure V. Kayser, Landenberg, PA (US); Vidhika S. Damani, Newark, DE (US)

(73) Assignee: University of Delaware, Newark, DE (US)

(21) Appl. No.: 18/847,860

(22) PCT Filed: Mar. 17, 2023
(86) PCT No.: PCT/US2023/015527

§ 371 Date: Sep. 17, 2024

Related U.S. Application Data
(60) Provisional application No. 63/320,797, filed on Mar. 17, 2022.

(51) Int. Cl. C08F 293/00; C08J 3/075; H01M 4/02

(52) U.S. Cl. CPC C08F 293/00; C08J 3/075; H01M 4/02; H01M 2004/023; H01M 2300/0085

(57) ABSTRACT

Disclosed herein is a composition comprising a block copolymer-polyelectrolyte complex. The block copolymer-polyelectrolyte complex comprises a water-insoluble polycationic doped conducting polymer substantially homogeneously dispersed throughout a block-copolymer. The block-copolymer comprises at least one thermo-responsive polymeric block and at least one water-soluble polyanionic polymeric block comprising a plurality of negatively charged moieties. The water-insoluble polycationic doped conducting polymer comprises a plurality of positively charged moieties, such that at least a portion of the positively charged moieties form an ionic bond with at least a portion of the negatively charged moieties throughout the block copolymer-polyelectrolyte complex.

### CROSS-REFERENCE TO RELATED APPLICATION

This application claims priority to U.S. Provisional Patent Application No. 63/320,797, filed Mar. 17, 2022, the entire disclosure of which is incorporated herein by reference for all purposes.

### BACKGROUND OF THE INVENTION

Most bioelectronic devices that are currently used in healthcare for applications such as single-point health monitoring, drug delivery, and tissue engineering rely on inorganic materials such as silicon, carbon nanotubes, and metals. However, with the growing need for wearable, and implantable electronics, properties such as flexibility (low Young's modulus), light weight, dynamic behavior, and mixed ionic-electronic conduction have gained prominence. Flexibility and light weight play an important role in devices that are in close contact with curvilinear surfaces like skin and biological tissue, for better mechanical compliance. In addition, most biological systems display dynamic behavior in response to a change in their environment, making dynamicity an attractive property for wearable and implantable electronics. Finally, biological processes like inter- and intra-cellular transfer, metabolic processes, and production of lipids and proteins occur with ionic transport. Thus, simultaneous ionic and electronic conduction, also called mixed ionic-electronic conduction, provides opportunities to seamlessly interface electronic devices with cells. Inorganic materials, while displaying high conductivity, do not intrinsically possess these properties, and thus, there is a need for a new class of materials to bridge this gap.

Soft electronics or organic electronics can act as the link between the conductivity of inorganic materials (metals) and the low Young's modulus and ionic conductivity of soft biological tissue. This class of materials consists of organic semiconducting polymers such as poly(3,4-ethylenedioxythiophene) (PEDOT), polypyrrole, and polyaniline which allow the flow of charge carriers due to their π-conjugated backbones. Organic electronics have been commercialized for applications like printed electronics, anti-static coatings, in display systems as organic light-emitting diodes (OLEDs) and organic photovoltaic cells (OPVs). In addition to improved flexibility and softness, organic electronics can also offer mixed ionic-electronic conduction, which is the simultaneous transport of charges and ions. This property has been harnessed in devices such as organic electrochemical transistors (OECTs), which have been used in biosensing, wearable technology, assistive motion, and neuromorphic devices. Conductive polymers are more advantageous for biological applications because they provide a continuous conductive path for charge carriers (electrons or holes) without affecting the mechanical compliance of the material with biological tissue and by providing mixed ionic-electronic conduction. Among conducting polymers, poly(3,4-ethylenedioxythiophene) or PEDOT is preferred due to its stability in oxygen and high conductivity. However, it is insoluble in most solvents and thus, is often used along with the polyelectrolyte poly(styrene sulfonate) (PSS) to stabilize the doped form of PEDOT. The resulting polyelectrolyte complex, PEDOT:PSS, is water-dispersible, biocompatible, displays oxygen stability, and provides mixed ionic-electronic conduction. PSS is hydrophilic and enables the dispersion of the otherwise insoluble PEDOT in water and also acts as its counterion to balance the charges present due to the hole carriers in doped PEDOT. In water, the conformation of PEDOT:PSS has been described as a colloidal gel particle with a micelle structure; the hydrophobic PEDOT core region being surrounded by a hydrophilic PSS shell.

In contrast to inorganic materials, polymeric electronics also offer opportunities for customization by chemical functionalization. Chemical tunability could be used to induce dynamic behavior in conductive materials, to mimic the tendencies of biological tissues. One method of incorporating dynamic behavior in organic electronics is by combining them with stimuli-responsive materials. Stimuli-responsive materials are a class of materials that respond to a change in stimulus with a change in properties or behavior. These changes can be triggered by stimuli such as pH, temperature, light, chemicals, voltage, mechanical force, or magnetic field. Physically, the response can be observed as a color change, swelling-deswelling, gelation, precipitation or a change in mechanical properties. Of the various mechanisms of stimuli-response, thermal response is the most widely studied due to its ease of implementation and a wide variety of trigger methods (direct application of heat, Joule heating using electricity, cross-linking induced thermo-response). Thermo-responsive polymers have been reported for applications in controlled drug delivery and small-molecule release, soft actuators and haptics, biosensing devices, biomimetics and tunable catalysis.

There are few examples of polymeric systems that are both thermo-responsive and conductive, but most are limited to conductive hydrogels or polymer blends. While some reports rely on carbon nanotubes for conductivity, others use conductive polymers like PEDOT, polypyrrole (PPy), or polyaniline (PANI). A nanocomposite approach has been reported in the literature, where carbon nanotubes and Laponite, a nanoclay, were loaded into a poly(N-isopropylacrylamide) (PNIPAM) hydrogel to yield a conductive and thermo-responsive composite. The hydrogels exhibited surface conductivity of 0.16-0.2 S/m and a conductivity change of 10% with a 50% change in pressure. However, a change in resistance as a result of the thermo-response was not reported. Another approach of in-situ polymerization of PPy in a thermo-responsive PNIPAM hydrogel has been reported in the literature, where the hydrogel displayed a shrinkage in volume on heating, which corresponded with an increase in conductivity (from 0.02 S/m to 0.08 S/m). This was attributed to the close packing of PPy globules at higher temperature due to deswelling. However, it was observed that PPy did not penetrate deeply into the bulk of PNIPAM. Another approach uses crosslinked PPy and PANI inside PNIPAM hydrogels. However, due to the presence of interpenetrating networks, the thermo-response was very slow (˜ 800 minutes recovery time from 50° C. to 25° C. In yet another approach, commercial PEDOT:PSS (Clevios) was loaded with N-isopropylacrylamide (NIPAM) and photopolymerized to form a PEDOT:PSS/PNIPAM hydrogel, which was then loaded with functional boron nitride nanosheets for self-healing and adhesion. The ionic conductivity of the material was not investigated. The main challenge with these approaches is that the loading of conductive materials into hydrogels does not guarantee uniformity of charge transfer since their distribution in the 3D network may not be homogenous. Additionally, because these are crosslinked materials, they are difficult to incorporate into devices using common spin-coating techniques. Another approach attempted to overcome this challenge, by grafting PNIPAM onto a PEDOT based structure, poly(3,4-propylenedioxythiophene) (ProDOT), to yield a thermo-responsive dispersion of PEDOT in water. This approach displayed a reversible precipitation at T>lower critical solution temperature (LCST) from an aqueous solution. However, since ProDOT is hydrophobic, increasing the ProDOT content decreased the LCST (further away from body temperature) to 26° C. This outcome reduced the possibility of incorporating this material into devices for biosensing. The ionic conductivity was not reported. In yet another approach, a PEDOT:PSS/PNIPAM blend was used for cell capture and release. The blend was functionalized with fibronectin to induce cell adhesion at room temperature. On heating the film above 37° C., the film shrank in volume due to the thermo-response of PNIPAM and released the cells. Electrochemical impedance spectroscopy (EIS) was used to study the change in conductivity of the material in the swelled and shrunken conformations. A 33% decrease in resistance was noted for the shrunken state, which was attributed to closer packing of polymeric chains due to reduced volume. However, the insulating nature of PNIPAM-rich regions in the blend led to a hindrance in ionic conductivity and an increase in impedance on increasing the temperature.

Hence, there is a need for a new approach to homogenize stimuli-response and conductivity and to provide thermo-responsive and stimuli-responsive polymers, for use in tissue engineering, wearable electronics, and theranostic devices.

### SUMMARY OF THE INVENTION

Soft conducting materials, which can conduct both ions and electrons, can play a significant role in bridging the gap of mechanical and electronic properties between conventional electronics (such as metals and inorganic semiconductors) and biological tissue. For instance, mixed ionic-electronic conductive hydrogels have gained importance due to their low Young's modulus close to animal tissues. However, the synthetic strategies for conductive hydrogels are limited to composite approaches, which are non-homogenous and bulky. The use of these materials for applications such as tissue engineering can lead to increased risk of scar tissue formation and infection and longer recovery time and cost. To overcome these challenges, a conducting block copolymer-polyelectrolyte complex is disclosed herein, which is liquid at room temperature and forms a gel at human body temperature. This injectable conductive gel is based on a poly (N-isopropylacrylamide)-block-poly (styrene sulfonate) (PNIPAM-b-PSS), which is used as a scaffold for the conductive polymer poly (3,4-ethylenedioxythiophene) (PEDOT). PNIPAM has been widely probed due to its thermal stimuli-response close to body temperature. PNIPAM exhibits a lower critical solution temperature transition in water above 32° C. It has been found that at particular molecular weights, ratios of PSS to PNIPAM, and concentrations in solution, the PEDOT:PSS-b-PNIPAM complex exhibits a reversible sol-gel transition in water close to body temperature. This novel polyelectrolyte complex is the first reported reversibly gellable conducting polymer and has potential for use as minimally invasive injectable gels for tissue engineering, wearable electronics and theranostic devices.

In an aspect of the invention, a composition comprises a block copolymer-polyelectrolyte complex. The block copolymer-polyelectrolyte complex comprises a water-insoluble polycationic doped conducting polymer substantially homogeneously dispersed throughout a block-copolymer. The block-copolymer comprises at least one thermo-responsive polymeric block and at least one water-soluble polyanionic polymeric block comprising a plurality of negatively charged moieties. The water-insoluble polycationic doped conducting polymer comprises a plurality of positively charged moieties, such that at least a portion of the positively charged moieties form ionic bonds with at least a portion of the negatively charged moieties throughout the block copolymer-polyelectrolyte complex.

In an embodiment of the composition, the thermo-responsive polymeric block comprises poly(N-isopropylacrylamide), poly(N, N-diethylacrylamide), poly(methyl vinyl ether), poly(vinyl N-alkyl ethers), or poly(N-vinyl caprolactam).

In another embodiment of the composition, the polyanionic polymeric block comprises polystyrene sulfonate, polymaleic acid, or polyacrylic acid.

In yet another embodiment of the composition, the polycationic doped conducting polymer comprises poly(3,4-ethylenedioxythiophene), polypyrrole, polyaniline, polythiophene, poly(3,4-propylenedioxythiophene), or poly(3,4-phenylenedioxythiophene).

In an embodiment of the composition, the thermo-responsive polymeric block comprises poly(N-isopropylacrylamide), the polyanionic polymeric block comprises polystyrene sulfonate, and the polycationic doped conducting polymer comprises poly(3,4-ethylenedioxythiophene).

In another embodiment, the thermo-responsive polymeric block and the water-soluble polyanionic polymeric block are present in a mass ratio in a range of 4:1 to 1:4, and the polyanionic polymer and the polycationic doped conducting polymer are present in a mass ratio in a range of 5:1 to 2:1.

In an embodiment, the block copolymer has a molecular weight in a range of 10 to 100 kDa, and the polycationic doped conducting polymer has a molecular weight in a range of 0.2 to 40 kDa.

In another embodiment, the composition exhibits a reversible sol-gel transition at a temperature range of 25° C. or more and 45° C. or less, or the composition precipitates at a temperature in a range of 25° C. or more and 45° C. or less.

In an embodiment, the composition is electrically conducting in liquid, gel, and solid states.

In an aspect, a medical device comprises the composition as disclosed hereinabove, where the medical device is an implantable medical device, a wearable medical device, or a theranostic device.

In an embodiment of the medical device, the composition, as disclosed hereinabove, is present in an injectable scaffold, a 3D printed scaffold, a biomedical implant, an injectable electrode, a wearable electrode, a biosensor, an actuator, or an electrochemical transistor.

In another aspect, a method of preparing the composition, as disclosed hereinabove, comprises providing an aqueous solution of a neutral or acidified block-copolymer, where the block-copolymer comprises a thermo-responsive polymeric block and a water-soluble polyanionic polymeric block comprising a plurality of negatively charged moieties. The method further comprises adding a monomer of the polycationic doped conducting polymer to the aqueous solution with vigorous stirring, to disperse the monomer substantially homogeneously, under ambient conditions in the presence of an oxidant and a catalyst to obtain the block-polyelectrolyte complex comprising the polycationic conducting polymer substantially homogeneously dispersed throughout the block-copolymer.

In an embodiment of the method, the oxidant comprises potassium persulfate, hydrogen peroxide, iron (III) sulfate, or iron (III) chloridepersulfates, peroxides, iron (III) oxidants, or a combination thereof.

In another embodiment of the method, the catalyst comprises iron (III) chloride, iron (III) sulfate, hydrogen peroxide, or a combination thereof.

In another embodiment of the method, the monomer is added in an amount of 0.1 to 0.5 mmol, at a temperature in a range of 10° C. to 45° C.

### BRIEF DESCRIPTION OF THE DRAWINGS

FIG. 1 shows an exemplary synthesis of a thermo-responsive and conductive block copolymer-polyelectrolyte complex: PEDOT:PSS-block-PNIPAM, according to embodiments of the present invention.

FIG. 2 (Prior Art) shows an exemplary synthesis of PSS-block-PNIPAM.

FIGS. 3A-3C show NMR spectra of (A) a crude synthetic mixture of PSS Macro-CTA; (B) a crude synthetic mixture of PSS-b-PNIPAM; and (C) purified PSS-b-PNIPAM after dialysis.

FIG. 4 shows GPC chromatograms of the PSS Macro-CTA and PSS-b-PNIPAM.

FIG. 5A shows pictures of the PEDOT:PSS-b-PNIPAM complex at room temperature and at 40° C. showing the reversible gelation.

FIG. 5B shows the storage modulus (G′) and the loss modulus (G″) of the PEDOT:PSS-b-PNIPAM complex as a function of temperature in a range of 20° C. to 50° C. at 5° C./min.

FIGS. 6A-6B show EIS studies on the thermo-responsive conductive block copolymer-polyelectrolyte complex (PEDOT:PSS-block-PNIPAM) in solution in water at 23° C. and as a gel at 37° C., where FIG. 6A is a Bode plot, and FIG. 6B is a Nyquist plot (inset: equivalent circuit model).

FIG. 7 shows GPC chromatograms of PSS and two batches of PSS-b-PNIPAM, where the peaks of PSS-b-PNIPAM overlap for both batches, demonstrating the reproducibility of the method according to embodiments of the present invention.

FIG. 8 shows the effect of PEDOT loading on the viscosity of the PEDOT:PSS-b-PNIPAM complex, where (a) PSS: PEDOT=4.8:1; (b) PSS: PEDOT=3.5:1; and (c) PSS: PEDOT=2.5:1.

FIGS. 9A-9B show the effect of PEDOT loading on the conductivity of the PEDOT:PSS-b-PNIPAM complex, where FIG. 9A shows a Nyquist Plot, and FIG. 9B shows a Bode Plot, both obtained from electrochemical impedance spectroscopy.

FIG. 10 shows mechanical properties of the PEDOT:PSS-b-PNIPAM complex, where FIG. 10(a) is a temperature sweep to determine gelation temperature or crossover point; FIG. 10(b) is a time sweep to determine gelation time; FIG. 10(c) is G′ and G″ for one cycle; and FIG. 10(d) shows loss modulus for 10 heat-cool cycles.

FIG. 11 shows a Nyquist plot of the PEDOT:PSS-b-PNIPAM complex in liquid and gel states at a pH of 5.4.

FIG. 12 shows PEDOT:PSS blended with PNIPAM (a) at room temperature; and (b) above the LCST.

FIG. 13 shows a schematic illustration of an exemplary block copolymer-polyelectrolyte complex of the present invention for use as an interface between a biological system such as a nerve cell and an electronic device, such as a biomedical device, according to embodiments of the present invention.

### DETAILED DESCRIPTION OF THE INVENTION

As used herein, the term “gel” is used interchangeably with “hydrogel” and refers to a hydrated polymeric material that has a three-dimensional solid structure (i.e., a polymer matrix) marked by a gelation temperature in water, which corresponds to a crossover point between G′ and G″ as a function of temperature, i.e., onset of gelation occurs when G″=G′ or tan δ=1. After gelation point, or at a temperature greater than the gelation temperature, G′>G.″

As used herein, the term “transition temperature” is used interchangeably with “gelation temperature” of the block copolymer-polyelectrolyte complex and is marked by the crossover point between G′ and G″ (i.e., G″=G′ or tan δ=1) as a function of temperature.

As used herein the term “thermo-responsive polymeric block” or “thermoresponsive polymer” refers to a polymer which undergoes a physical change, such as gelation, precipitation, or a change in mechanical properties, when exposed to external thermal stimuli such as an increase or decrease in temperature. For example, PNIPAM is a well known thermo-responsive polymer, which undergoes a phase transition from soluble in water to insoluble in water at about 32-35° C.

The term “water-soluble” with respect to a polymer or a polymeric block of a copolymer in water means that the polymer or the polymeric block of the copolymer is soluble in water at room temperature (i.e., from about 20° C. to about 30° C.) to obtain an aqueous solution having at least about 0.05% by weight of the polymer or the polymeric block of a copolymer, based on the total weight of the solution.

As used herein, the term “water-insoluble” with respect to a compound or material in water means that the polymer or the polymeric block of the copolymer is not soluble in water at room temperature (as defined above).

As used herein, the term “water-insoluble polycationic doped conducting polymer” is used interchangeably with “doped polycationic conducting polymer,” “polycationic doped conducting polymer,” “polycationic conducting polymer,” and “doped conducting polymer.”

As used herein, the term “gellable conducting polymer” is used interchangeably with thermo-responsive and conductive polyelectrolyte complex, block copolymer-polyelectrolyte complex, and compositions comprising such polymer complexes, that retain at least some ionic and electronic conductivity upon a change in state from liquid to gel and vice versa, when exposed to external thermal stimuli such as an increase or decrease in temperature. In an embodiment, the two states: liquid and gel may have different amount of ionic and electronic conductivity. As used herein, the term “reversible gellable conducting polymer” refers to gellable conducting polymers that can undergo a physical change from liquid to gel and vice versa, upon exposure to external stimuli such as a change in temperature.

In doped conducting polymers, an electron is removed from the valence band by oxidation (p-doping) or is added to the conducting band by reduction (n-doping). Hence, polycationic doped conducting polymer has p-doping. An example of a polycationic doped conducting polymer is a doped PEDOT, as shown below:

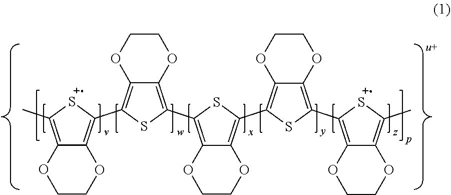

Disclosed herein is a composition comprising a block copolymer-polyelectrolyte complex, which is a thermo-responsive and stimuli-responsive block copolymer-polyelectrolyte complex. The block copolymer-polyelectrolyte complex includes a polycationic doped conducting polymer substantially homogeneously dispersed throughout a block copolymer. The block-copolymer includes at least one thermo-responsive polymeric block and at least one water-soluble polyanionic polymeric block comprising a plurality of negatively charged moieties. And, the water-insoluble, polycationic doped conducting polymer comprising a plurality of positively charged moieties. In the block copolymer-polyelectrolyte complex, at least a portion of the positively charged moieties of the polycationic doped conducting polymer form ionic bonds with at least a portion of the negatively charged moieties of the polyanionic polymeric block substantially homogeneously throughout the block copolymer-polyelectrolyte complex. In an embodiment, the block-copolymer is not a blend of the polyanionic polymer and the thermo-responsive polymer. In another embodiment, the block copolymer-polyelectrolyte complex is not a copolymer of the block copolymer and the polycationic doped conducting polymer. In other words, in the block copolymer-polyelectrolyte complex, there is no covalent bond between the block copolymer and the polycationic doped conducting polymer. In another embodiment, the block copolymer-polyelectrolyte complex is not a blend of the conducting polyelectrolyte complex (such as PEDOT:PSS) and the thermo-responsive polymer (such as PNIPAM).

In an embodiment, the composition further comprises water. The block copolymer-polyelectrolyte complex may be present in any suitable amount in an aqueous solution, such as for example, in an amount of 1-10 wt. %, or 1.5-7.5 wt. %, or 2.5 to 5.0 wt %., based on the total amount of the solution.

In an embodiment of the composition, the thermo-responsive polymeric block may include any suitable polymer which exhibits a lower critical solution temperature (LCST) transition. A thermo-responsive polymer is characterized by having certain properties, such as polarity, solubility, or hydrophobicity, altered by changes in temperature. In an embodiment, the thermo-responsive polymer in an aqueous solution changes from hydrophilic to hydrophobic when the temperature increases above the LCST temperature. One such example is poly(N-isopropylacrylamide) (PNIPAM), which is one of the most widely studied thermo-responsive polymers. PNIPAM displays a LCST transition in the presence of water at 32-35° C., i.e., close to body temperature. This response is possible due to the presence of hydrophilic amide functional groups in the repeat unit, that hydrogen bond with water at T<LCST. At T>LCST, PNIPAM displays inter- and intra-molecular hydrogen bonding and expels the water molecules, thus showing a transition from an extended and hydrophilic random coil to a compact and hydrophobic globule with an increase in temperature.

In an embodiment, the thermo-responsive polymer block of the block copolymer exhibits a LCST transition in water at a temperature in a range of 25 to 45° C., or 30 to 40° C., or 31 to 38° C., or 31 to 36° C., or 32 to 35° C. Any suitable technique may be used for measuring LCST, such as, for example, dynamic light scattering, cloud point turbidity measurement, or rheology.

Other suitable examples of thermo-responsive polymers include, but are not limited to, poly(N, N-diethylacrylamide) having a transition temperature in a range of 32-34° C., poly(methyl vinyl ether) having a transition temperature of 37° C., poly(vinyl N-alkyl ethers) having a transition temperature in a range of 30-40° C., poly(N-vinyl caprolactam) having a transition temperature in a range of 35-37° C., poly [2-(dimethylamino)ethyl methacrylate] (pDMAEMA), hydroxypropylcellulose, poly-2-isopropyl-2-oxazoline, or a combination thereof.

In an embodiment of the composition, the polyanionic polymeric block of the block copolymer comprises a water-soluble sulfonated ion-conducting aromatic polymer, such as polystyrene sulfonate with sulfonate ion as the negatively charged moiety. In another embodiment, the polyanionic polymeric block comprises polymaleic acid, poly(acrylic acid) (PAA), poly(methacrylic acid) (PMAA), poly(acrylic acid-co-methacrylic acid) (pAA-pMAA), poly(ethyl acrylic acid) (PEAA), poly(acrylic acid-co-ethyl acrylic acid) (pAA-pEAA), poly(methacrylic acid-co-ethyl acrylic acid) (pMAA-pEAA), poly [2-Acrylamidoglycolic acid], poly [2-methacrylamidoglycolic acid], polymers grafted with (trifluoromethane)sulfonylimide (TFSI), or a combination thereof. The polyanionic polymeric acid block may include carboxylate as the negatively charged moiety.

In an embodiment of the composition, the polycationic doped conducting polymer comprises polypyrrole, polyaniline, polythiophene, poly(3,4-ethylenedioxythiophene), poly(3,4-propylenedioxythiophene), poly(3,4-phenylenedioxythiophene), poly(p-phenylene vinylene) s, polyacetylenes, or a combination thereof. Suitable derivatives of polypyrrole include, but are not limited to the following substituted polymers: poly(N-methylpyrrole), poly(N-butylpyrrole), poly [N-(2-cyanoethyl)pyrrole], poly [N-(2-carboxyethyl)pyrrole], poly(N-phenylpyrrole), poly [N-(6-hydroxyhexyl)pyrrole], and poly [N-(6-tetrahydropyranylhexyl)pyrrole], among others. The polycationic doped conducting polymer may include C, N, or S as the positively charged moieties.

In another embodiment of the composition, the thermo-responsive polymeric block comprises poly(N-isopropylacrylamide), the polyanionic polymeric block comprises polystyrene sulfonate, and the polycationic doped conducting polymer comprises poly(3,4-ethylenedioxythiophene). The resulting block copolymer-polyelectrolyte complex has the following structure:

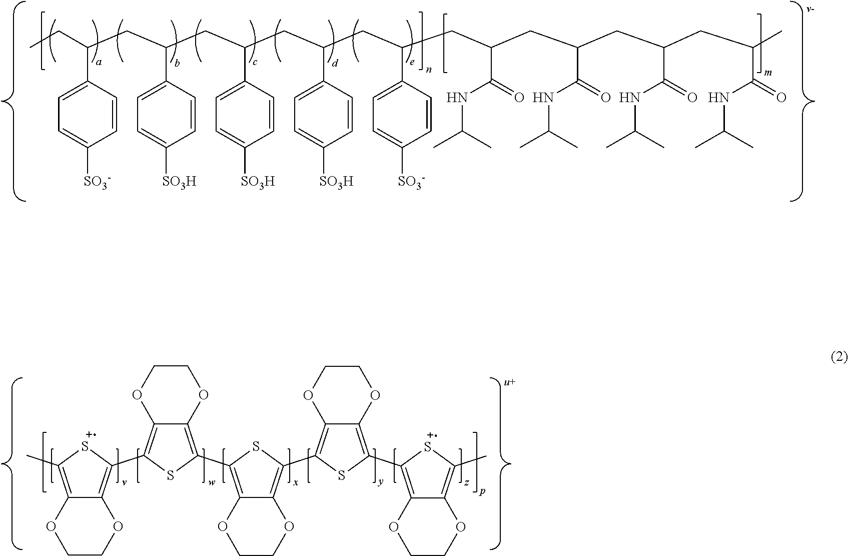

where a, b, c. d, e, v, w, x, y, and z are independently 0 or 1; n, m, and p can have any suitable value. For example, n can be at least 40, or 50, or 60, or 70 or 80, or 90, or 100, or 100, or 110, or 120, or 130, or 140, or 150, or 200, or 225, and at most 500, or 400, or 300, or 250 or 200, or 100, or 50; m can be at least 70, or 80, or 90, or 100, or 150, or 200, or 250, or 275, or 300, or 325, or 350, or 375, or 400 and at most 600, or 500, or 400, or 300, or 250, or 200, or 100; and p can be at least 2, or 5, or 10, or 15, or 20, or 25, or 30, or 35, or 40, or 45, or 50, and at most 100, or 80, or 70, or 60. In an embodiment n is in a range of 40 to 250, or 50 to 200, or 60 to 150; m is in a range of 70 to 400, or 90 to 350, or 100 to 310; and p is in a range of 2 to 50, or 3 to 30, or 7 to 20. The polycationic doped conducting polymer and the polyanionic polymeric block of the block-copolymer may have any suitable charge. For example, v and u can be in a range of 2 to 50, or 3 to 30, or 7 to 20.

The thermo-responsive polymeric block and the water-soluble polyanionic polymeric block may be present in any suitable amounts in the block-copolymer. In an embodiment of the composition, the thermo-responsive polymeric block and the water-soluble polyanionic polymeric block may be present in a mass ratio in a range of 5:1 to 1:4, or 4:1 to 2:1, or 3:1 to 1:1, or 2:1 to 1:2.

In yet another embodiment of the composition, the polyanionic polymer and the polycationic doped conducting polymer may be present in a mass ratio in a range of 7:1 to 1:1, or 6:1 to 2:1, or 4.5:1 to 1.5:1.

The block copolymer can have any suitable molecular weight, such as in a range of 10 to 100 kDa, or 12 to 75 kDa, or 13 to 60 kDa. In an embodiment, the molecular weight is determined by gel permeation chromatography (GPC) by refractive index (RI) detection and calibrated against polystyrene sulfonate standards. The polycationic doped conducting polymer can have any suitable molecular weight, such as likely in a range of 0.14 to 40 kDa, or 0.5 to 35 kDa, or 1 to 30 kDa, which cannot be confirmed exactly but estimated to be above 0.14 kDa from UV-Vis spectroscopy.

In an embodiment, the composition exhibits a reversible sol-gel transition at a temperature range of 25 to 45° C., or 30 to 40° C., or 31 to 38° C., or 31 to 36° C., or 32 to 35° C.

In another embodiment, the composition precipitates at a temperature in a range of 25 to 45° C., or 30 to 40° C., or 31 to 38° C., or 31 to 36° C., or 32 to 35° C.

In yet another embodiment, the composition is electrically conducting, via both ionic and electronic conduction, in each of the liquid, gel, and solid states. In an embodiment, the composition has an ionic conductivity in the liquid state in a range of 0.01 to 50 mS/cm, or 0.05 to 30 mS/cm, or 0.1 to 20 mS/cm and electronic conductivity in a range of 0.001 to 1 mS/cm, or 0.05 to 0.75 mS/cm, or 0.04 to 0.5 mS/cm. In another embodiment, the composition has an ionic conductivity in the gel state in a range of 0.01 to 50 mS/cm, or 0.05 to 45 mS/cm, or 0.1 to 40 mS/cm and electronic conductivity in a range of 0.01 to 1 mS/cm, or 0.03 to 0.07 mS/cm, or 0.035 to 0.065 mS/cm.

In an embodiment, the composition comprises a pH buffer. As used herein, the buffer solution is an acid or a base aqueous solution consisting of a mixture of a weak acid and its conjugate base, or vice versa. The composition as disclosed hereinabove exhibits reversible gelation at both acidic and neutral pH.

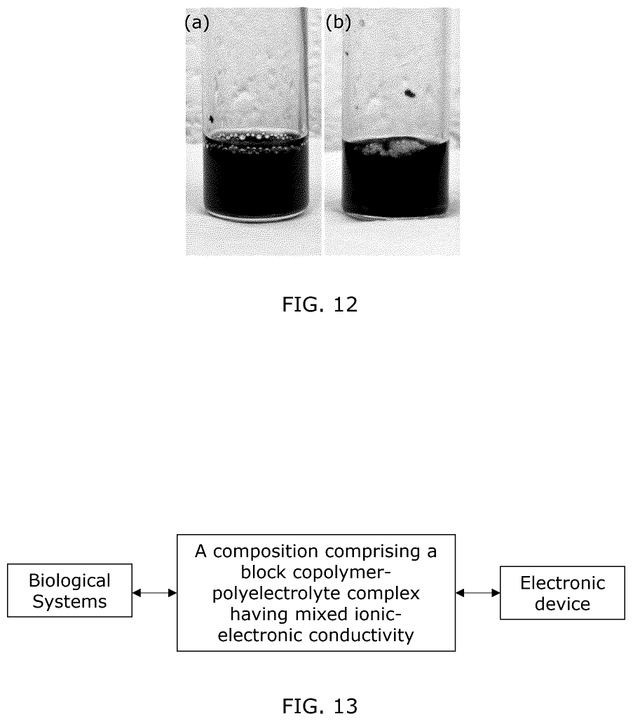

An aspect of the invention is a medical device comprising the composition as disclosed hereinabove. In an embodiment, the composition exhibits both electronic and ionic conductivities. In another embodiment, the medical device is an implantable medical device. In yet another embodiment, the medical device is a wearable medical device. In an embodiment, the medical device is a theranostic device. The medical device may comprise the composition in any suitable form, such as in an injectable scaffold, a 3D printed scaffold, a biomedical implant, an injectable electrode, a wearable electrode, a biosensor, an actuator, or an electrochemical transistor. FIG. 13 shows a schematic illustration of an exemplary composition comprising a block copolymer-polyelectrolyte complex of the present invention for use as an interface between a biological system such as for example, a nerve cell and an electronic device such as an external biomedical device. In another embodiment, an exemplary composition, as disclosed hereinabove, comprising a block can be used in tissue engineering. In an embodiment, the composition has a gelation temperature that is close to a subject's body temperature and the composition is used as a minimally invasive injectable gel for tissue engineering, wearable electronics, and/or theranostic devices. The subject can be a mammal, a bird, a fish, a plant, or a fungus. In an embodiment, the composition is used as a wound dressing material. In another embodiment, the tissue is muscle, bone, brain, and/or cartilage tissue.

In another embodiment, a precipitate of the composition is used in a form of solid thin film after spin-coating or casting, in organic electrochemical transistors, field-effect transistors, or electrodes.

An aspect of the invention is a method of preparing the composition as disclosed hereinabove. The method comprises providing an aqueous solution of a neutral or acidified block-copolymer, wherein the block copolymer comprises a thermo-responsive polymer block and a water-soluble polyanionic polymeric block. The method further comprises adding a monomer of the polycationic doped conducting polymer to the aqueous solution while vigorously stirring to substantially homogeneously disperse the monomer in the aqueous solution, under ambient conditions in the presence of an oxidant and a catalyst to obtain the block-polyelectrolyte complex comprising the polycationic doped conducting polymer substantially homogeneously dispersed throughout the block-copolymer. Any suitable method can be used to disperse the water-insoluble monomer in the aqueous solution, such as magnetic stirrer, mechanical stirrer, and ultrasound bath. In an embodiment, the aqueous solution was stirred at a speed of 500 to 1400 rpm.

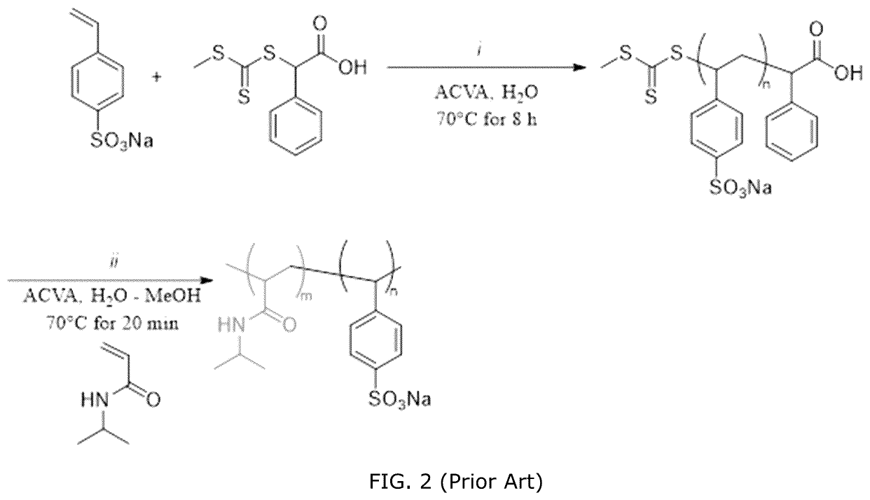

The neutral or acidified block-copolymer can be prepared by any suitable known method, such as shown in the FIG. 2.

Any suitable oxidant may be used, such as, for example, sodium persulfates, peroxides, or iron (III) oxidants, or a combination thereof. Suitable examples of oxidants include, but are not limited to, potassium persulfate, hydrogen peroxide, iron (III) sulfate, or iron (III) chloride oxidants. In an embodiment, the oxidant may be present in an amount of 0.01 mmol to 1 mmol, or 0.05 to 0.75 mmol, or 0.1 to 0.5 mmol.

Any suitable catalyst may be used, such as, for example iron (III) chloride. Suitable examples of catalyst include, but are not limited to, hydrogen peroxide, iron (III) sulfate. In an embodiment, the mass ratio of catalyst to polyanionic polymer may be 0.0001:1 to 0.2:1, or 0.005:1 to 0.015:1, or 0.007:1 to 0.01:1.

Any suitable monomer of the polycationic doped conducting polymer may be used, including, but not limited to, ethylene dioxythiophene (EDOT), pyrrole, aniline, thiophene, 3,4-propylenedioxythiophene, 3,4-phenylenedioxythiophene, p-phenylene vinylene, acetylene, or a combination thereof. Suitable derivatives of pyrrole include, but are not limited to the following substituted monomers: N-methylpyrrole, N-butylpyrrole, N-(2-cyanoethyl)pyrrole, N-(2-carboxyethyl)pyrrole, N-phenylpyrrole, N-(6-hydroxyhexyl)pyrrole, and N-(6-tetrahydropyranylhexyl)pyrrole, among others. In an embodiment, the monomer is present in an amount in a range of 0.01 to 3 mmol, or 0.05 to 1 mmol, or 0.1 to 0.75 mmol.

In an embodiment, the step of adding a monomer of the polycationic doped conducting polymer to the aqueous solution is carried out at a temperature in a range of 10 to 15° C., or 18 to 25° C., or 25 to 40° C.

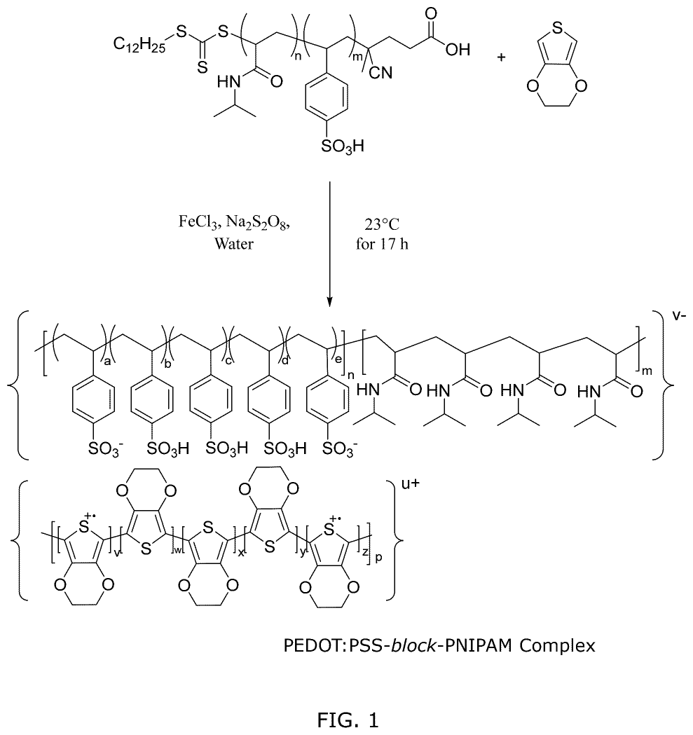

An aspect of the invention is a new approach to homogenize stimuli-response and conductivity by synthesizing a block copolymer that exhibits a thermo-response and acts as a matrix for a conjugated conductive moiety such as PEDOT (FIG. 1) has been demonstrated. In this approach, block copolymers of PNIPAM with PSS were synthesized and used as a matrix and counter-ion for the semiconducting polymer, PEDOT. It has been shown hereinbelow that PEDOT:PSS-block-PNIPAM complex is thermo-responsive; it is a liquid at room temperature and forms a gel at human body temperature. It is also electronically and ionically conductive, as shown by electrochemical impedance spectroscopy. This novel block copolymer-polyelectrolyte complex is the first reported reversibly gellable conducting polymer and has potential for use as minimally invasive injectable gels for tissue engineering, wearable electronics and theranostic devices.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. As used herein, the term “about” means within ±10% of the stated value, or within ±5% of the stated value, or within ±4% of the stated value, or within ±3.5% of the stated value, or within ±3% of the stated value, or within ±2% of the stated value, preferably within ±2% of the stated value, more preferably within ±1% of the stated value. The term “room temperature” when used herein, is intended to refer to a temperature of about 18° C. to about 25° C. It is not intended that the scope of the invention be limited to the specific values recited when defining a range.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions or processes. Additionally, in some embodiments, the invention can be construed as excluding any element or process step not specified herein.

### EXAMPLES

Examples of the present invention will now be described. The technical scope of the present invention is not limited to the examples described below.

### ABBREVIATIONS

ACVA: 4,4′-Azobis (4-cyanovaleric acid)
CTA: chain transfer agent
DMF: dimethylformamide
MTPA: α-methyltrithiocarbonate-S-phenylacetic acid
NaSS: sodium styrene sulfonate
PANI: polyaniline
PEDOT: poly(3,4-ethylenedioxythiophene)
PNIPAM: poly(N-isopropylacrylamide)
PPy: polypyrrole
PSS: poly(styrene sulfonate)
EIS: Electrochemical impedance spectroscopy
GPC: Gel permeation chromatography
NMR: Nuclear magnetic resonance
RI: refractive index

### Materials

Diethyl ether, carbon disulfide, sodium methoxide, ethyl acetate, α-bromophenylacetic acid, hydrochloric acid, sodium chloride, n-hexane were obtained from Sigma Aldrich and used without further purification. Sodium styrene sulfonate (NaSS) was recrystallized from ethanol/water. ACVA was recrystallized from methanol/water. poly(N-isopropylacrylamide) (PNIPAM) was recrystallized from n-hexane.

### Hydrogel Preparation:

All hydrogels were prepared by dissolving block copolymer-polyelectrolyte complex to DI water with a concentration of 3.4 wt %, based on the total amount of the solution. The polymer solutions were stored in 25° C. before following characterizations.

### Characterization

### NMR

Nuclear magnetic resonance (NMR) spectra were recorded on a Bruker 400 MHz spectrometer at room temperature. For PSS CTA and PNIPAM-block-PSS, the reaction progress was monitored using 1H NMR in deuterium oxide.

### Gel Permeation Chromatography (GPC)

Molecular weight and molecular weight distribution were determined by Gel Permeation Chromatography (GPC) using a Tosoh GPC and a differential refractive index detector. Analytical polar GPC precolumn (50 mm*8 mm, 10 μm particle size) and analytical polar GPC column (300 mm*8 mm, 10 μm particle size) were purchased from PSS GRAM. A mixture of 90% v/v dimethylformamide (DMF) with 10% v/v deionized water was used as the eluent. 0.1 w/v % of LiBr was added to DMF. PSS standards were used for calibration.

### Electrochemical Impedance Spectroscopy (EIS)

Electrochemical impedance spectroscopy was performed on A Metrohm Autolab PGSTAT128N and in a Faraday cage. A customized cell was made from conductive copper foil tape and a polystyrene cuvette. The cuvette was lined with copper foil on two opposite inner surfaces. The copper foil was 10 mm wide and roughly 50 mm long. The conducting block polyelectrolyte complex was poured into the cuvette at room temperature (liquid state), assuring close contact with copper foil covered surfaces. A constant current of 0.5 mA was passed through the whole cell adopting the two-electrode setup, through connecting the protruded portion of copper foil tapes. Electrochemical impedance spectroscopy (EIS), scanning from 0.1 to 1E5 Hz at 0 V bias (vs. counter electrode) with 10 mV amplitude, was recorded at 25° C. and 40° C. to obtain electrochemical impedance in liquid and gel state respectively.

### Rheological Measurement

Rheological measurements were performed using an ARG2 rheometer with a parallel plate geometry (r=10 mm). The storage modulus (G′), loss modulus (G″), and tan δ (G″/G′) were determined in the temperature range of 20° C. to 50° C., using a gradual increase in temperature (5° C./min). The gelation temperature of the block copolymer-polyelectrolyte complex was determined by the crossover point between G′ and G″ (i.e., G″=G′ or tan δ=1).

### Methods

### Reference Example 1: Synthesis of the MTPA Chain Transfer Agent

α-Methyltrithiocarbonate-S-phenylacetic acid (MTPA) was synthesized as reported in the literature. Carbon disulfide (1.08 mL, 17.88 mmol) was dissolved in 9.75 mL of diethyl ether and added dropwise to a solution of sodium methoxide (1.035 g, 19 mmol) in 30 mL of diethyl ether at room temperature. The mixture was stirred for 2 hours at room temperature. Diethyl ether was then removed by decantation and evaporation. Ethyl acetate (33 mL) was added to the resulting yellow powder to dissolve it. The insoluble part was filtered out. To the solution, α-bromophenylacetic acid (2.94 g, 13.6 mmol) was added. The reaction mixture was heated to 70° C. and stirred overnight with reflux. The reaction mixture was washed thrice with 1M HCl and subsequently with saturated NaCl solution. The organic layer was dried over sodium sulfate and the product recrystallized from n-hexane/ethyl acetate to obtain MTPA (yield=600 mg).

### Reference Example 2: Synthesis of a Block Copolymer: PSS-Block-PNIPAM

Sodium styrene sulfonate (NaSS, 2.06 g, 10 mmol) was dissolved in 10 mL water, along with MTPA (26 mg, 0.1 mmol) and ACVA (5.6 mg, 0.02 mmol). The reaction was degassed for 30 minutes under nitrogen. The reaction proceeded for 8 hours at 70° C. to yield the PSS Macro-CTA in its sodium form. It was purified by dialysis in deionized water for 48 hours and dried under vacuum. NIPAM (2.26 g, 20 mmol), PSS Macro-CTA (0.963 g, 0.05 mmol), and ACVA (5.75 mg, 0.02 mmol) were then dissolved in 4 mL of a 1:1 water: methanol solution. The reaction mixture was degassed for 30 mins under nitrogen and the reaction proceeded for 8 hours at 70° C. to yield PSS-block-PNIPAM. It was purified by dialysis in DI water for 48 hours.

### Example 1: Synthesis of a Block Copolymer-Polyelectrolyte Complex: PEDOT:PSS-b-PNIPAM Complex

PSS-b-PNIPAM was stirred over acidic resin (Dowex Marathon C). 250 mg of acidified PSS-b-PNIPAM was dissolved in 7 ml of water (concentration=35.7 g/mL). Once completely dissolved, iron (III) chloride (3.5 μL, 10% w/v solution) and sodium persulfate (36.8 mg, 0.15 mmol) were added. After stirring for 10 minutes, EDOT (12 UL, 0.1 mmol) was added and the reaction was left to stir vigorously for 13 hours at room temperature. Initially, the monomer EDOT in the aqueous solution looked non-homogeneous dispersion, which turned into a homogeneous dispersion with vigorous stirring, and as the synthesis of PEDOT progressed with continued vigorous stirring, the dispersion changed color from blue in the beginning to blue-black at the end of the reaction. PEDOT:PSS-block-PNIPAM was purified by stirring over acidic and basic (Lewatit Ion Exchange) resins.

### Results and Discussion

To achieve the thermo-responsive and conductive polymers described herein, a supporting PSS-based electrolyte was synthesized. PSS-b-PNIPAM was chosen as a model system, as it was previously reported to undergo micellization above 35° C. Hence, it was hypothesized that this polymer would be an effective thermo-responsive matrix for the PEDOT conductive polymer. PSS-b-PNIPAM was synthesized by RAFT polymerization following a procedure previously reported (FIG. 2). PSS with a molecular weight of around 20 kDa was targeted to insure good dispersion of the PEDOT for the subsequent step. In order to maximize the thermal response, and potentially induce gelation, a 1:2 mass ratio of PSS to PNIPAM was targeted.

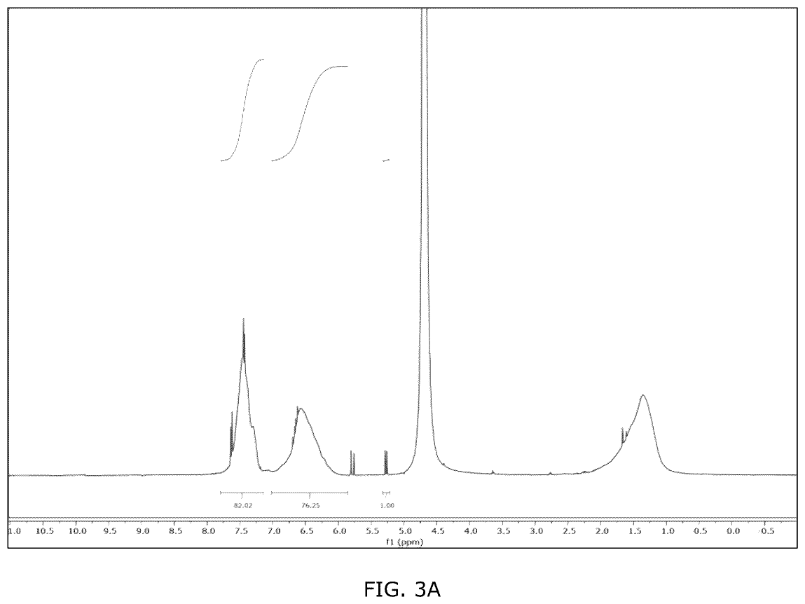

The conversions of NaSS and NIPAM were monitored by 1H NMR to determine monomer conversion and estimate the molecular weight (FIG. 3). Using 1H NMR, the PSS Macro-CTA was found to have a molecular weight of 19.9 kDa, which is slightly overestimated when compared to the GPC results (Mn=14.8 kDa) (Table 1). A low dispersity was obtained for the size distribution (Ð=1.2) indicating the efficiency of the MTPA chain transfer agent.

TABLE 1
Molecular weight of the PSS Macro-CTA and PSS-b-PNIPAM.

| | | | Number | | | |
|---|---|---|---|---|---|---|
| | | Theoretical | Average | | Repeat Unit | Mass |
| | Monomer | Molecular | Molecular | | Ratio of | Ratio of |
| Sample | conversion | Weight^{a} | Weight^{b} | Dispersity^{b} | PSS:PNIPAM^{a} | PSS:PNIPAM^{b} |
| PSS | 98% | 19.9 kDa | 14.8 kDa | 1.2 | — | — |
| PSS-b- | 85% | 55 kDa | 49 kDa | 1.3 | 1:5.6 | 1:2.3 |
| PNIPAM | | | | | | |

^{a}Calculated by ¹H NMR.
^{b}Measured by GPC against PSS standards.

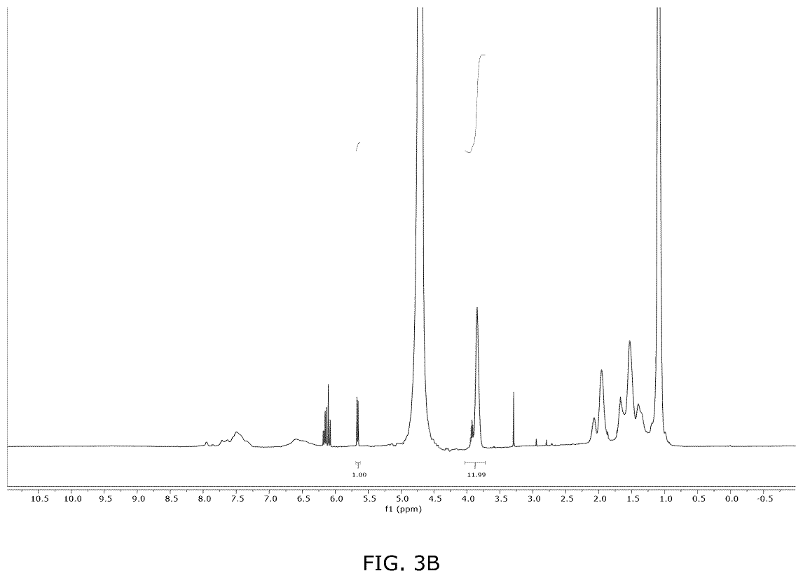

Next, the polymer chain was extended with PNIPAM to form PSS-b-PNIPAM. GPC confirmed the formation of block-copolymer (FIG. 4) as shown by the shift in the retention time trace and the monomodal peak distribution. A low dispersity is also maintained for PSS-b-PNIPAM (Ð=1.3). The overall molecular weight of the block copolymer was found to be 49 kDa, which overall gave a mass ratio of PSS to PNIPAM of 1:2.3.

The thermo-responsive behavior of the block copolymer was observed when an aqueous solution of the polymer was placed at 40° C.

The final synthetic step is the polymerization of the conductive polymer within this thermo-responsive matrix. Therefore, a block copolymer-polyelectrolyte complex, PEDOT:PSS-b-PNIPAM complex was synthesized by oxidative polymerization of EDOT in water in the presence of PSS-b-PNIPAM. Conditions similar to those generally reported for the synthesis of PEDOT:PSS were used, except that the polymerization was performed at room temperature and over shorter times (FIG. 1).

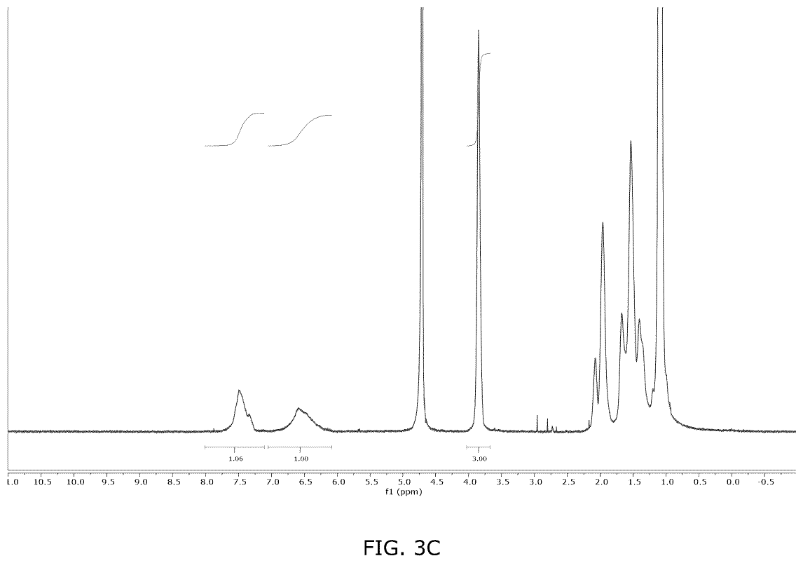

After purification of the PEDOT:PSS-b-PNIPAM complex, a gelation process was observed upon increasing the temperature of the solution. The gelation was characterized both qualitatively and quantitatively by varying the temperature of PEDOT:PSS-b-PNIPAM complex. The sample was visually observed to transition reversibly from liquid to gel at a temperature between 35° C. and 40° C. (FIG. 5a). To confirm the sol-gel transition, rheology measurements were performed using an ARG2 rheometer with a parallel plate geometry (r=10 mm). The storage modulus (G′), loss modulus (G″), and tan δ (G″/G′) were determined in the temperature range of 20° C. to 50° C., using a gradual increase in temperature (5° C./min) (FIG. 5b). The temperature of gelation of PEDOT:PSS-b-PNIPAM complex was determined by the crossover point between G′ and G″ (i.e., G″=G′ or tan δ=1) to be 35° C., with a fully gelled sample close to 37° C. This gelation temperature, which is close to body temperature, is ideal for applications in biology, particularly for injectable conductive hydrogels.

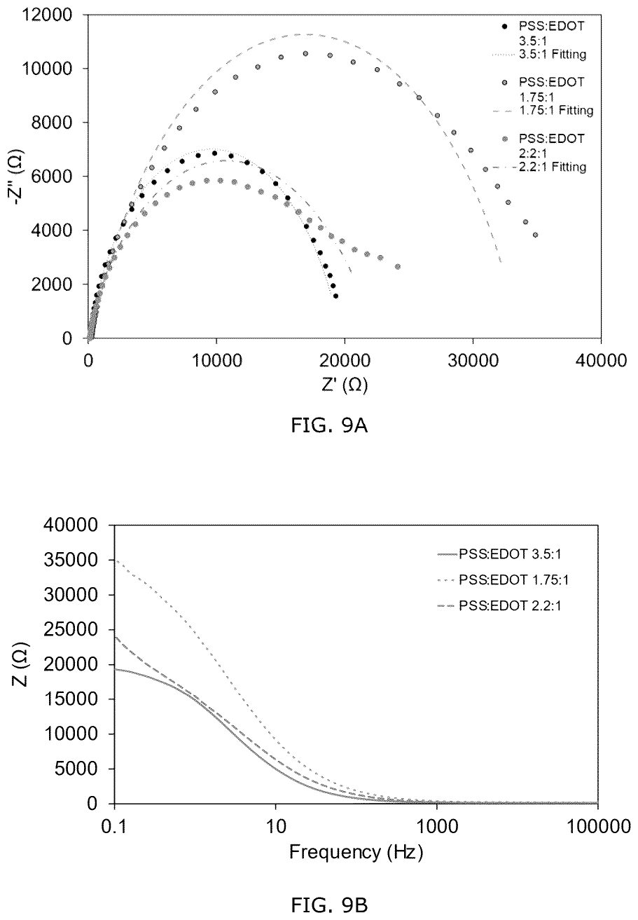

To study the reversibility of gelation, oscillatory rheology was used—the temperature was increased and decreased for 10 cycles (FIG. 10(d)). An increase in loss modulus was observed as the sample was exposed to temperature fluctuations above the LCST for a long time due to evaporation and change in concentration. Some parts of the sample gelled permanently between the two plates of the rheometer, leading to a non-homogenous composition and change in mechanical properties. The storage modulus of the gel was found to be around 20 Pa after gelation.

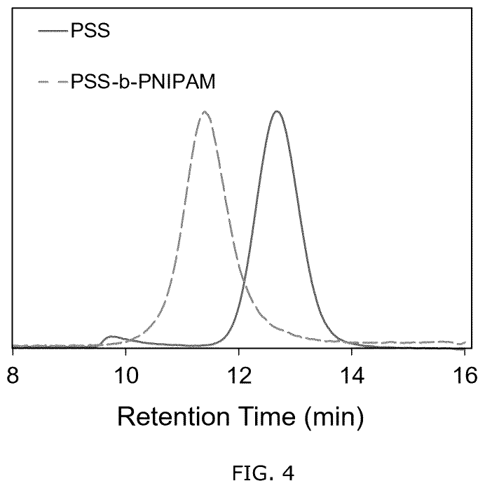

Lastly, electrochemical impedance spectroscopy (EIS) was used to study the electronic properties of PEDOT:PSS-b-PNIPAM complex (FIG. 6). First, the impedance of the sample was recorded at room temperature. Then, the sample was gradually heated to 37° C. and the temperature was allowed to stabilize. The impedance was measured again, once the sample was fully gelled. It was observed that the value of impedance fell to half when the temperature was increased and the gel was formed. To extract the ionic and electronic resistance, an equivalent circuit model was fitted to the Nyquist plot. The ionic and electronic conductivity were calculated to be 0.13 mS cm-1 and 0.05 mS cm-1, respectively.

### Conclusions

Disclosed herein is believed to be the first example of a reversible sol-gel transition in water for a conductive polymer. The polymer is based on the polyelectrolyte complex of a conducting polymer, PEDOT, with a polyelectrolyte block copolymer, PSS-b-PNIPAM, synthesized by RAFT polymerization. The gelation of PEDOT:PSS-b-PNIPAM complex is triggered by a small change in temperature, close to 35° C., resulting from the LCST of PNIPAM. This thermo-responsive conductive polymer is expected to have widespread applications in bioelectronics, including for injectable electronics for accelerating tissue/nerve repair, adaptable electronic devices for neuromorphic computing, and organic electrochemical transistor theranostic devices (e.g., biosensing combined with drug delivery or cell release).

### Example 2: Reproducibility and Scale-Up

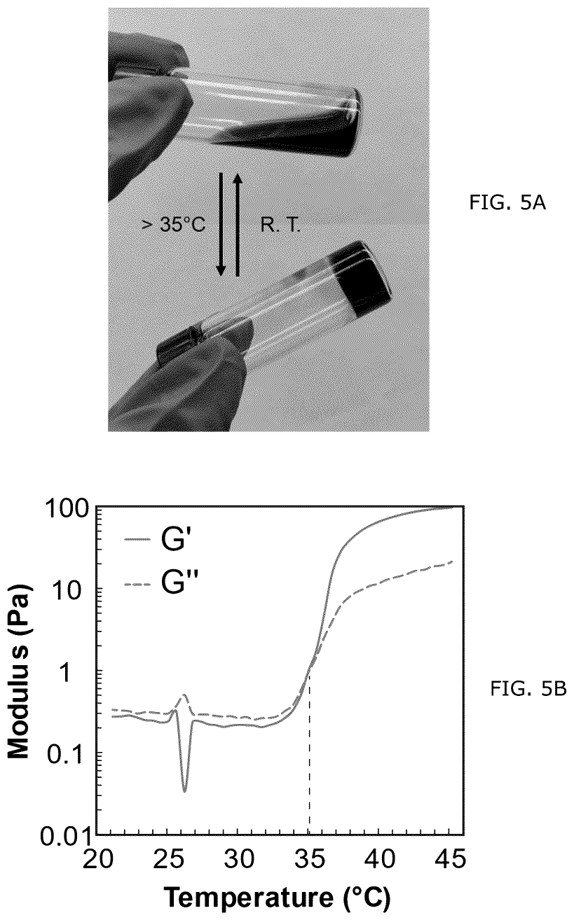

To test reproducibility, the sample in triplicates was synthesized. First, a new batch of PSS-block-PNIPAM was synthesized using the procedure described in Reference Example No. 2, and characterized for conversion, molecular weight and dispersity. The chromatogram of the block copolymer from gel permeation chromatography was found to overlap with the chromatogram from the original batch, proving the reproducibility of the block copolymer synthesis (FIG. 7).

Next, the PEDOT:PSS-b-PNIPAM complex was synthesized using the procedure described in Example No. 1, and its gelation and conductivity were studied. It was found that the loss and storage modulus profiles as well as electronic and ionic conductivity of the samples were reproducible. The synthesis was scaled-up to about 3×. PSS-b-PNIPAM was stirred over acidic resin (Dowex Marathon C). 726 mg of acidified PSS-b-PNIPAM was dissolved in 20.3 ml of water (concentration=35.7 mg/mL). Once completely dissolved, iron (III) chloride (10 μL, 10% w/v solution) and sodium persulfate (104 mg, 0.425 mmol) were added. After stirring for 10 minutes, EDOT (34 μL, 0.283 mmol) was added and the reaction was left to stir vigorously for 16 hours at room temperature. PEDOT:PSS-b-PNIPAM was purified by stirring over acidic and basic (Lewatit Ion Exchange) resins. The reversible gelation, crossover point (gel temperature), storage and loss modulus profiles and electronic and ionic conductivity remained identical post scale-up. This scaled-up sample was used for further mechanical characterization, to study the effect of pH on gelation and for cell cytotoxicity experiments.

### Example 3: Effect of Block Size and Ratio

The molecular weight of PNIPAM is known to influence the temperature and speed of the thermo-response. Thus, the molecular weight (number of repeat units in a block, i.e. block size) of PNIPAM and the ratio of PSS to PNIPAM were varied. It was observed that lowering the molecular weight of PSS slowed down the thermo-response and resulted in PEDOT samples that became cloudy or formed a slime-like consistency on heating above the LCST. The results are summarized in Table 2.

TABLE 2
Effect of block size (number of repeat units
in a block) and ratio on thermo-response.

| | | Thermo-response of |
|---|---|---|
| Sample No. | Sample | PEDOT:PSS-b-PNIPAM |
| Example No. 3.1 | PSS₅₀-b-PNIPAM₂₉₉ | Became viscous and cloudy, |
| | | no gelation |
| Example No. 3.2 | PSS₇₂-b-PNIPAM₂₉₉ | Gelation |
| Example No. 3.3 | PSS₁₃₅-b-PNIPAM₂₃₁ | Became viscous |
| Example No. 3.4 | PSS₁₉₄-b-PNIPAM₉₄ | No visible thermo-response* |
| Example No. 3.5 | PSS₁₉₄-b-PNIPAM₂₇₉ | No visible thermo-response* |

*These samples had a lower concentration than the rest, which would explain the lack of visible thermo-response.

### Example 4: Effect of the Ratio of PEDOT:PSS

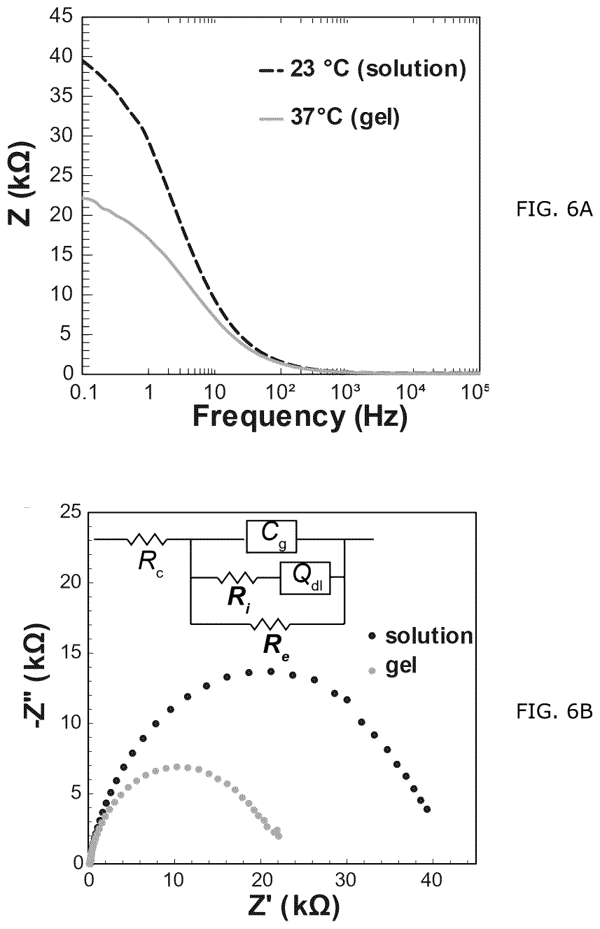

Clevios PH1000 (commercially available PEDOT:PSS which has a high conductivity) has a molar ratio of 1.86:1 PSS:EDOT. Thus, to improve the conductivity of gellable PEDOT, the molar ratio of PSS:EDOT was varied from 3.5:1 to 1.75:1. Visually, there was a noticeable difference in the viscosity at room temperature (FIG. 8). The sample with highest loading of PEDOT was most viscous (FIG. 8(c)). Due to the gel-like consistency at room temperature, there appeared to be a negligible change in its physical state on heating.

Table 3 summarizes the conductivity values, obtained by fitting equivalent circuit models to electrochemical impedance spectroscopy (EIS) data (Nyquist Plot) for a composition comprising PEDOT:PSS₇₂-b-PNIPAM₂₉₉, where Ci=ionic conductivity, Ce=electronic conductivity

TABLE 3

| | | Liquid (mS/cm) | | Gel (mS/cm) | |
|---|---|---|---|---|---|
| | pH | Cᵢ | Cₑ | Cᵢ | Cₑ |
| Example No. 3.2 | 2.5 | 11.5 | 0.02 | 0.13 | 0.05 |
| Example No. 4 | 5.4-6.5 | 13.5 | 0.027 | 34 | 0.04 |

As, can be seen from Table 3, the pH had a bigger influence on the ionic conductivity as compared to the electronic conductivity, and even bigger influence in the gel state.

### Conductivity

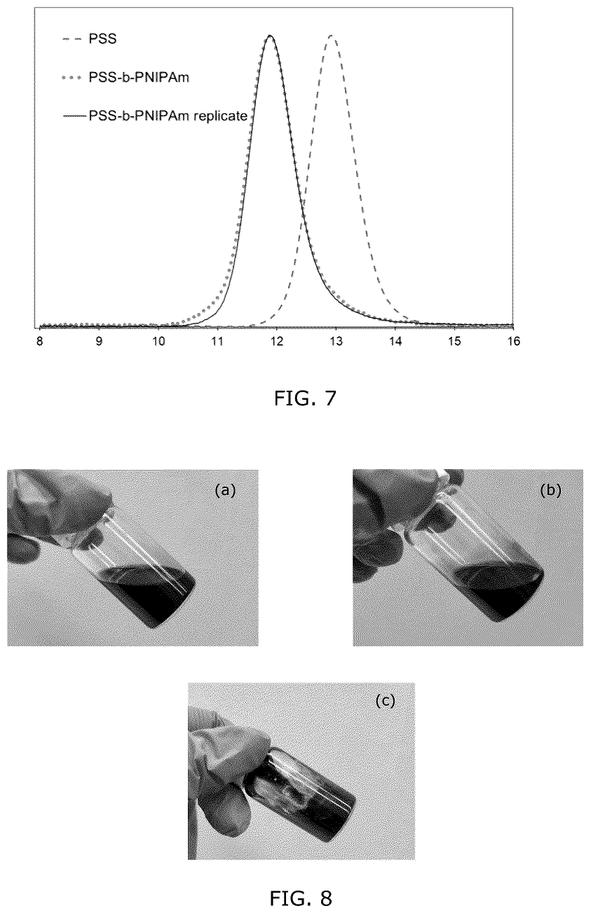

The conductivity of the samples was studied using electrochemical impedance spectroscopy (FIG. 9). Contrary to general expectations, the Nyquist plot showed that increasing the loading of PEDOT increased the impedance (FIG. 9(a)). In addition, the equivalent circuit model that was used to determine the electronic and ionic conductivity deviated from the experimental results for higher loading. In addition, a Bode plot (FIG. 9B) was generated to depict the high frequency response of the complex with varying molar ratios of PEDOT:PSS. From the Bode plot, it was determined that the lowest overall impedance profile was obtained for the sample with lowest loading of PEDOT (PSS:EDOT=3.5:1) (FIG. 9(b)), and thus, this ratio was used for all further experiments.

### Mechanical Properties

Rheological measurements were performed to determine the mechanical properties of gellable PEDOT (FIG. 10). The rheometer ARG2 from TA Instruments was used. Based on the viscosity and volume of sample, parallel plate geometry with radius=40 mm was chosen. The storage modulus or elastic modulus (G′) and loss modulus or viscous modulus (G″) and tan δ (G″/G′) were characterized in the temperature range of 20° C.-50° C. To determine the temperature of gelation, the crossover point of PEDOT:PSS-block-PNIPAM (tan δ=1, G″=G′) was determined (FIG. 10(a)). For this study, the temperature was increased gradually at a constant rate (5° C./min) and G′ and G″ were recorded. It was found that the gelation temperature was 35° C. Further, a time sweep was performed at 36° C. to determine the gelation time (FIG. 10(b)).

To study the reversibility of gelation, oscillatory rheology was used—the temperature was increased and decreased for several cycles (FIG. 10(c), 10(d)). An Increase in loss modulus was observed as the sample was exposed to temperature fluctuations above the LCST for a long time due to evaporation and change in concentration. Some parts of the sample gelled permanently between the two plates of the rheometer, leading to a non-homogenous composition and change in mechanical properties.

### Example 5: Effect of pH

PEDOT:PSS-b-PNIPAM has a pH of 2-2.5 due to the acidic nature of PSS-H. However, this pH is too acidic for use in a cell culture. Thus, an objective of this study was to neutralize the pH of the gel to make it suitable for cell cytotoxicity studies. A 1× solution of PBS (phosphate buffer solution) with pH=7.4 was used to perform ion-exchange on the PEDOT gel. 3 mL of PEDOT gel was maintained at 50° C., and 8-10 mL hot 1×PBS (50° C.) was added for ion exchange. The PBS buffer was changed 5-6 times and its pH was monitored over a period of 24 hours. Finally, the PBS was decanted, and the gel was allowed to cool down to a liquid. The pH was measured using pH paper and Accumet AB15 pH meter. After 24 hours, the pH of buffer and PEDOT gel stabilized at 6.5.

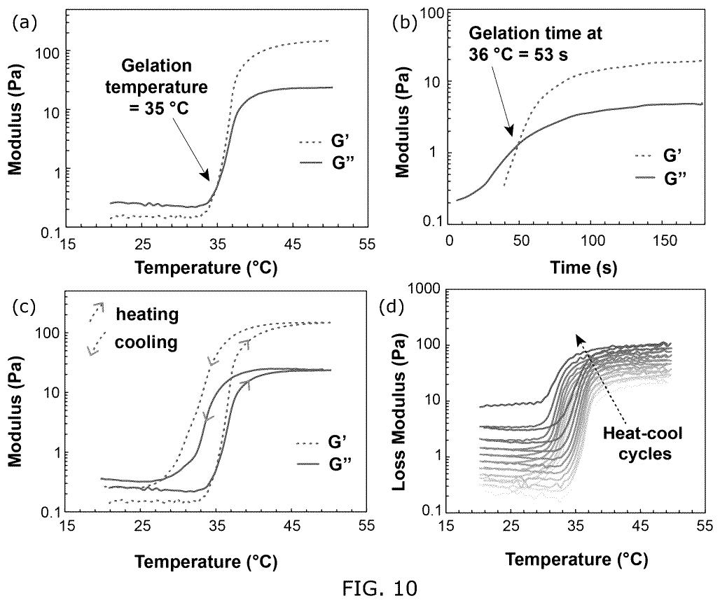

The ionic and electronic conductivity of PEDOT gel were analysed post-ion exchange (FIG. 11). It was found that the electronic conductivity fell to 0.04 mS/cm but the ionic conductivity increased to 34 mS/cm post-exchange.

### Comparative Example 1: A Blend of PNIPAM and PEDOT:PSS

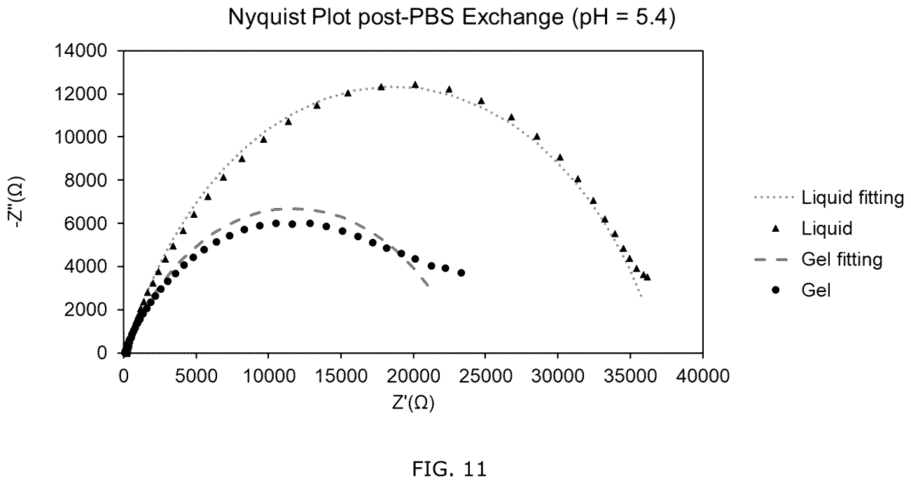

10 mg of PNIPAM homopolymer was blended with 1 mL of Clevios PH1000 (commercially available PEDOT:PSS). The mixture was first stirred at room temperature and then ultrasonicated to ensure a homogenous blend. Then, it was heated above the LCST of PNIPAM. It was observed that above the LCST, PNIPAM crashed out of the solution and the blend became non-homogenous. PEDOT:PSS was unaffected and remained dispersed (FIG. 12)

Although the invention is illustrated and described herein with reference to specific embodiments, the invention is not intended to be limited to the details shown. Rather, various modifications may be made in the details within the scope and range of equivalents of the claims and without departing from the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A composition comprising a block copolymer-polyelectrolyte complex, wherein the block copolymer-polyelectrolyte complex comprises:
(i) a block-copolymer comprising at least one thermo-responsive polymeric block and at least one water-soluble polyanionic polymeric block comprising a plurality of negatively charged moieties; and
(ii) a water-insoluble polycationic, doped conducting polymer comprising a plurality of positively charged moieties, wherein the polycationic doped conducting polymer is substantially homogeneously dispersed throughout the block-copolymer, and wherein at least a portion of the positively charged moieties form an ionic bond with at least a portion of the negatively charged moieties throughout the block copolymer-polyelectrolyte complex.

2. The composition according to claim 1, wherein the thermo-responsive polymeric block comprises poly(N-isopropylacrylamide), poly(N, N-diethylacrylamide), poly(methyl vinyl ether), poly(vinyl N-alkyl ethers), or poly(N-vinyl caprolactam).

3. The composition according to claim 1, wherein the polyanionic polymeric block comprises polystyrene sulfonate, polymaleic acid, or polyacrylic acid.

4. The composition according to claim 1, wherein the doped conducting polymer comprises poly(3,4-ethylenedioxythiophene), polypyrrole, polyaniline, polythiophene, poly(3,4-propylenedioxythiophene), or poly(3,4-phenylenedioxythiophene).

5. The composition according to claim 1, wherein the thermo-responsive polymeric block comprises poly(N-isopropylacrylamide), the polyanionic polymeric block comprises polystyrene sulfonate and the polycationic doped conducting polymer comprises poly(3,4-ethylenedioxythiophene).

6. The composition according to claim 1, wherein the thermo-responsive polymeric block and the water-soluble polyanionic polymeric block are present in a mass ratio in a range of 4:1 to 1:4.

7. The composition according to claim 1, wherein the polyanionic polymer and the doped conducting polymer are present in a mass ratio in a range of 5:1 to 2:1.

8. The composition according to claim 1, wherein the block copolymer has a molecular weight in a range of 10 to 100 kDa, and
wherein the polycationic doped conducting polymer has a molecular weight in a range of 0.2 to 40 kDa.

9. The composition according to claim 1, wherein the composition exhibits a reversible sol-gel transition at a temperature range of 25° C. or more and 45° C. or less.

10. The composition according to claim 1, wherein the composition precipitates at a temperature in a range of 25° C. or more and 45° C. or less.

11. The composition according to claim 1, wherein the composition is electrically conducting in liquid, gel, and solid states.

12. A medical device comprising the composition according to claim 1, wherein the medical device is an implantable medical device, a wearable medical device, or a theranostic device.

13. The medical device of claim 12, wherein the composition is present in an injectable scaffold, a 3D printed scaffold, a biomedical implant, an injectable electrode, a wearable electrode, a biosensor, an actuator, or an electrochemical transistor.

14. A method of preparing the composition according to claim 1, comprising:
(i) providing an aqueous solution of a neutral or acidified block-copolymer, wherein the block-copolymer comprises a thermo-responsive polymeric block and a water-soluble polyanionic polymeric block comprising a plurality of negatively charged moieties;
(ii) adding a monomer of the polycationic doped conducting polymer to the aqueous solution with vigorous stirring, under ambient conditions in the presence of an oxidant and a catalyst to obtain a block-polyelectrolyte complex comprising the polycationic doped conducting polymer substantially homogeneously dispersed throughout the block-copolymer.

15. The method according to claim 14, where the oxidant comprises potassium persulfate, hydrogen peroxide, iron (III) sulfate, or iron (III) chloridepersulfates, peroxides, iron (III) oxidants, or a combination thereof.

16. The method according to claim 14, where the catalyst comprises iron (III) chloride, iron (III) sulfate, hydrogen peroxide, or a combination thereof.

17. The method according to claim 14, wherein the monomer is present in an amount of 0.1 to 0.5 mmol.

18. The method according to claim 14, wherein the step of adding a monomer of the polycationic doped conducting polymer to the aqueous solution is carried out at a temperature in a range of 10° C. to 45° C.
